(19) United States
(12) Patent Application Publication
(10) Pub. No.: US 2026/0330488 A1
(43) Pub. Date: Oct. 22, 2026

(54) FORECASTING BUYER RETENTION: STRATEGIES FOR MANAGING CHURN AND ENHANCING CUSTOMER ENGAGEMENT

(71) Applicant: Dell Products L.P., Round Rock, TX (US)

(72) Inventors: Sirisha Karnam, Bangalore (IN); Lakshmi Nalam, Bangalore (IN)

(73) Assignee: Dell Products L.P., Round Rock, TX (US)

(21) Appl. No.: 19/185,355

(22) Filed: Apr. 22, 2025

(51) Int. Cl. G06Q 30/0202; G06Q 30/01; G06Q 30/0204

(52) U.S. Cl. CPC G06Q 30/0202; G06Q 30/01; G06Q 30/0204

(57) ABSTRACT

Methods, system, and non-transitory processor-readable storage medium for a buyer retention forecasting system are provided herein. An example method includes collecting historical buyer data comprising order experience, deployment experience, and support experience from enterprise hardware devices. The buyer retention forecasting system prepares feature buckets using the historical buyer data. The buyer retention forecasting system trains a Cox Proportional Hazards Model using the historical buyer data, and trains a Light Gradient Boosting Machine (LightGBM) model using the Cox Proportional Hazards Model to predict buyer state transitions. The buyer retention forecasting system periodically monitors buyer state transitions to determine if a buyer has transitioned from an active state to at least one other buyer state.

### FIELD

The field relates generally to forecasting buyer retention, within information processing systems.

### BACKGROUND

Buyers who purchase products on a reoccurring basis are active buyers. Lapsed buyers are customers who have not made a purchase within a defined period of time.

### SUMMARY

Illustrative embodiments provide techniques for implementing a buyer retention forecasting system in a storage system. For example, illustrative embodiments comprise a buyer retention forecasting system collecting historical buyer data comprising order experience, deployment experience, and support experience from enterprise hardware devices. The buyer retention forecasting system prepares feature buckets using the historical buyer data. The buyer retention forecasting system trains a Cox Proportional Hazards model using the historical buyer data. The buyer retention forecasting system trains a Light Gradient Boosting Machine (LightGBM) model using the Cox Proportional Hazards model to predict buyer state transitions. The buyer retention forecasting system periodically monitors buyer state transitions to determine if a buyer has transitioned from an active state to at least one other buyer state. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 illustrates an information processing system including a buyer retention forecasting system, in an illustrative embodiment.

FIG. 2 illustrates a flow diagram of a process for a buyer retention forecasting system, in an illustrative embodiment.

FIG. 3 illustrates the buyer retention forecasting system workflow, in an illustrative embodiment.

FIG. 4 illustrates the feature bucket, the feature, the issue, and the corrective action, in an illustrative embodiment.

FIG. 5 illustrates six example key identifiers mapped to feature set, in an example embodiment.

FIGS. 6 and 7 show examples of processing platforms that may be utilized to implement at least a portion of a buyer retention forecasting system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a buyer retention forecasting system, which technique may be used to collect historical buyer data comprising order experience, deployment experience, and support experience from enterprise hardware devices. The buyer retention forecasting system prepares feature buckets using the historical buyer data. The buyer retention forecasting system trains a Cox Proportional Hazards model using the historical buyer data. The buyer retention forecasting system trains a Light Gradient Boosting Machine (LightGBM) model using the Cox Proportional Hazards model to predict buyer state transitions. The buyer retention forecasting system periodically monitors buyer state transitions to determine if a buyer has transitioned from an active state to at least one other buyer state.

Customers generally fall into two categories, active and lapsed. Active customers continue to buy company products on a recurring basis. Lapsed customers are previously active customers who have not purchased a product from the company for a defined period of time, for example, four or more quarters. Lapsed customers are previously active customers who have since disengaged. Lapsed customers lead to lost revenue, lost market share, damaged brand perception, and costly campaigns to re-acquire as a customer.

Conventional technologies fail to predict customer transitions from active to lapsed status. Conventional technologies fail to use statistical modeling and machine learning techniques to predict customer transitions. Conventional technologies fail to model time-to-event data (i.e., customer churn). Conventional technologies react to customer churn after it occurs instead of anticipating it. Conventional technologies fail to integrate corrective actions directly into the framework for timely responses to potential customer lapses. Conventional technologies fail to leverage machine learning algorithms to enhance the framework's effectiveness. Conventional technologies fail to focus on optimizing customer lifetime value. Conventional technologies fail to use survival analysis techniques and latent states. Conventional technologies fail to integrate corrective actions so as to influence customer behavior.

By contrast, in at least some implementations in accordance with the current technique as described herein, an improvement in predicting which active buyers will transition into lapsed buyers is achieved by a buyer retention forecasting system that collects historical buyer data comprising order experience, deployment experience, and support experience from enterprise hardware devices. The buyer retention forecasting system prepares feature buckets using the historical buyer data. The buyer retention forecasting system trains a Cox Proportional Hazards model using the historical buyer data. The buyer retention forecasting system trains a Light Gradient Boosting Machine (LightGBM) model using the Cox Proportional Hazards model to predict buyer state transitions. The buyer retention forecasting system periodically monitors buyer state transitions to determine if a buyer has transitioned from an active state to at least one other buyer state.

Thus, a goal of the current technique is to capture customer state and predict customer transitions from active to lapsed status. Another goal is to leverage machine learning algorithms to enhance the framework's effectiveness. Another goal is to improve long-term customer value by enhancing customer lifetime value. Yet another goal is to integrate predictive analytics with actionable strategies to improve customer retention rates and maximize business outcomes.

In at least some implementations in accordance with the current technique described herein, the use of a buyer retention forecasting system can provide one or more of the following advantages: predict and anticipate customer transitions from active to lapsed status before it occurs, allowing for timely interventions, capture the latent active state of customers and predict when they might transition to a lapsed state, integrate corrective actions directly into the framework for timely responses to potential customer lapses so as to influence customer behavior, model time-to-event data (i.e., customer churn), and provide predictive modeling using LightGBM, a gradient boosting framework that offers advantages in terms of speed and interpretability.

In contrast to conventional technologies, in at least some implementations in accordance with the current technique as described herein, an improvement in predicting which active buyers will transition into lapsed buyers is achieved by a buyer retention forecasting system that collects historical buyer data comprising order experience, deployment experience, and support experience from enterprise hardware devices. The buyer retention forecasting system prepares feature buckets using the historical buyer data. The buyer retention forecasting system trains a Cox Proportional Hazards model using the historical buyer data. The buyer retention forecasting system trains a Light Gradient Boosting Machine (LightGBM) model using the Cox Proportional Hazards model to predict buyer state transitions. The buyer retention forecasting system periodically monitors buyer state transitions to determine if a buyer has transitioned from an active state to at least one other buyer state.

In an example embodiment of the current technique, the buyer retention forecasting system gathers the order experience data comprising customer name, physical address, hardware details, and order information.

In an example embodiment of the current technique, the buyer retention forecasting system collects system deployment details, data migration records, BIOS configuration data, asset tagging information, and installation records.

In an example embodiment of the current technique, the buyer retention forecasting system collects PC optimization records, proactive self-healing scripts, support ticket history, and chatbot interactions.

In an example embodiment of the current technique, the buyer retention forecasting system categorizes recentness of purchases into discrete bins, groups frequency of purchases, divides monetary values into ranges, and creates engagement level classifications.

In an example embodiment of the current technique, the buyer retention forecasting system creates monetary value buckets for total spending ranges and engagement buckets for email and website interactions.

In an example embodiment of the current technique, the buyer retention forecasting system trains the Cox Proportional Hazards model using purchase frequency data,
recency of last purchase, total purchase value, average order value, engagement metrics, customer lifetime value, and behavioral segmentation data.

In an example embodiment of the current technique, the buyer retention forecasting system trains the Cox Proportional Hazards model using product category preferences,
channel preferences, geographic location, inactive period length, and customer satisfaction data.

In an example embodiment of the current technique, the buyer retention forecasting system trains the LightGBM model using survival probabilities from the Cox Proportional Hazards model, and feature bucket data.

In an example embodiment of the current technique, the buyer retention forecasting system analyzes survival probabilities, predicts transitions from active to latent active states, and identifies risk of transition to lapsed state.

In an example embodiment of the current technique, the buyer retention forecasting system determines corrective actions using regression trees based on the detected buyer state transition and implements the corrective actions to transition the buyer state back to the active state.

In an example embodiment of the current technique, the buyer retention forecasting system trains the regression trees on past corrective actions and their outcomes.

In an example embodiment of the current technique, the buyer retention forecasting system generates a fix model using regression trees trained on past corrective actions, outcomes data, and feature impact analysis.

In an example embodiment of the current technique, the buyer retention forecasting system calculates a Customer Lifetime Value (CLV) using average annual revenue per customer, churn rate, and average customer lifespan.

In an example embodiment of the current technique, the buyer retention forecasting system sums total purchase values including deployment and support services and divides by purchase frequency.

In an example embodiment of the current technique, the buyer retention forecasting system determines average customer lifespan and uses the average customer lifespan to determine the churn rate as a percentage.

In an example embodiment of the current technique, the buyer retention forecasting system measures average time between purchases and calculates the reciprocal of average time between purchases.

In an example embodiment of the current technique, the buyer retention forecasting system maps key identifiers for lapsed buyer behavior comprising promoter/detractor scores, deal history, quality intelligence, product preferences, purchase order history, and
customer service interactions.

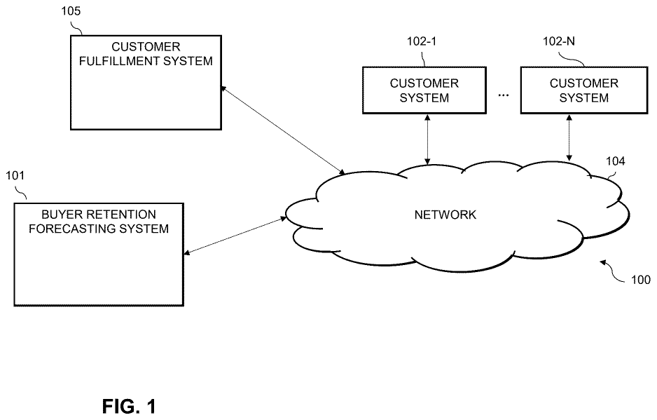

FIG. 1 shows a computer network (also referred to herein as an information processing system) 100 configured in accordance with an illustrative embodiment. The computer network 100 comprises a buyer retention forecasting system 101, a customer fulfillment system 105, and customer systems 102-N. The buyer retention forecasting system 101, customer fulfillment system 105, and customer systems 102-N are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. The buyer retention forecasting system 101 may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the buyer retention forecasting system 101, customer fulfillment system 105, and customer systems 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The buyer retention forecasting system 101, customer fulfillment system 105, and customer systems 102-N in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the buyer retention forecasting system 101 are one or more input-output devices, which illustratively comprise keyboards, displays or other types of input-output devices in any combination. Such input-output devices can be used, for example, to support one or more user interfaces to the buyer retention forecasting system 101, as well as to support communication between the buyer retention forecasting system 101 and other related systems and devices not explicitly shown. For example, a dashboard may be provided for a user to view results produced by the buyer retention forecasting system 101. One or more input-output devices may also be associated with any of the buyer retention forecasting system 101, customer fulfillment system 105, and customer systems 102-N.

Additionally, the buyer retention forecasting system 101 in the FIG. 1 embodiment is assumed to be implemented using at least one processing device. Each such processing device generally comprises at least one processor and an associated memory, and implements one or more functional modules for controlling certain features of the buyer retention forecasting system 101.

More particularly, the buyer retention forecasting system 101 in this embodiment can comprise a processor coupled to a memory and a network interface. The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the buyer retention forecasting system 101 to communicate over the network 104 with the buyer retention forecasting system 101, customer fulfillment system 105, and customer systems 102-N and illustratively comprises one or more conventional transceivers.

A buyer retention forecasting system 101 may be implemented at least in part in the form of software that is stored in memory and executed by a processor, and may reside in any processing device. The buyer retention forecasting system 101 may be a standalone plugin that may be included within a processing device.

It is to be understood that the particular set of elements shown in FIG. 1 for buyer retention forecasting system 101 involving the customer fulfillment system 105, and customer systems 102-N of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the buyer retention forecasting system 101 can be on and/or part of the same processing platform.

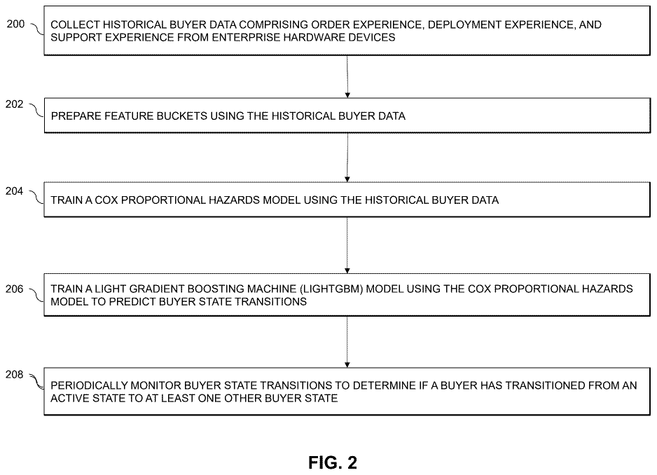

An exemplary process of buyer retention forecasting system 101 in computer network 100 will be described in more detail with reference to, for example, the flow diagram of FIG. 2.

FIG. 2 is a flow diagram of a process for execution of the buyer retention forecasting system 101 in an illustrative embodiment. It is to be understood that this particular process is only an example, and additional or alternative processes can be carried out in other embodiments.

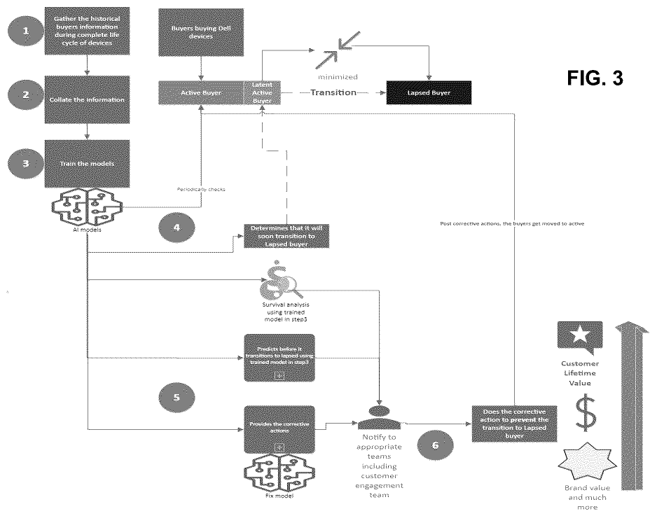

At 200, the buyer retention forecasting system 101 collects historical buyer data comprising order experience, deployment experience, and support experience from enterprise hardware devices. In an example embodiment, the buyer retention forecasting system 101 comprises several stages, the data collection stage, the feature preparation stage, the model training stage (in which two models are trained), the monitoring stage, the corrective actions stage, and the engagement stage. In the data collection state, the buyer retention forecasting system 101 collects historical buyer data, including their device lifecycle experiences. FIG. 3 illustrates the buyer retention forecasting system 101 workflow.

In an example embodiment, the buyer retention forecasting system 101 gathers the buyer experience during the complete lifecycle of the devices purchased. In an example embodiment, the buyer/customer places an order through a customer fulfillment system 105. For example, the buyer retention forecasting system 101 collects the order experience, deployment experience, and support experience. In an example embodiment, the order experience data comprises the customer's full name, the physical address where the product is delivered, hardware details (i.e., the item description), and order information, such as the order number and other details about the order. In an example embodiment, the customer may also enroll in additional services (i.e., purchasing additional services) during the order creation process, or later as an add-on order.

In an example embodiment, the deployment experience comprises system deployment details, data migration records, BIOS configuration data, asset tagging information, and installation records. For example, a customer may purchase a deployment client suite that streamlines hardware deployment to ensure efficient setup and minimize end-user downtime.

In an example embodiment, the support experience data comprises PC optimization records, proactive self-healing scripts, support ticket history, and chatbot interactions. For example, a customer may purchase a support suite that provides comprehensive support services that provides more assistance than basic technical support assistance, for example providing proactive self-healing scripts for devices. Once the customer orders and deploys the device(s), if the customer encounters any issues, the customer may try to resolve the issue using self-support using company-provided documentation, using a chatbot on a company website, and/or opening a support ticket.

At 202, in the feature preparation stage, the buyer retention forecasting system 101 prepares feature buckets using the historical buyer data. In an example embodiment, the buyer retention forecasting system 101 groups the information collected during the data collection stage into feature buckets, derived feature groups, and features. In an example embodiment, the buyer retention forecasting system 101 groups continuous features into discrete bins. In an example embodiment, the buyer retention forecasting system 101 categorizes recentness of purchases into discrete bins, groups the frequency of purchases, divides monetary values into ranges, and creates engagement level classifications. For example, the buyer retention forecasting system 101 creates recentness buckets, frequency buckets, monetary value buckets, and engagement buckets. In the recentness buckets, the buyer retention forecasting system 101 converts the time since the customer's last purchase into buckets, such as “recent”, “moderate”, and “long ago”. The buyer retention forecasting system 101 then assigns customers into the recentness buckets based on their recency. In the frequency buckets, the buyer retention forecasting system 101 groups the number of purchases into bins, such as “low”, “medium”, and “high”. The buyer retention forecasting system 101 then categorizes customers based on their purchase frequency.

In an example embodiment, the buyer retention forecasting system 101 creates monetary value buckets for total spending ranges and engagement buckets for email and website interactions. In the monetary value buckets, the buyer retention forecasting system 101 divides total spending into ranges, such as “low spenders”, “medium spenders” and “high spenders”, and then classifies customers accordingly. In the engagement buckets, the buyer retention forecasting system 101 creates bins for email opens, clicks, or website visits, such as “inactive”, “engaged”, and super-engaged”. The buyer retention forecasting system 101 then uses the engagement buckets to capture customer engagement levels.

At 204, the buyer retention forecasting system 101 trains a Cox Proportional Hazards model using the historical buyer data. In the model training stage, the buyer retention forecasting system 101 trains the Cox Proportional Hazards model and the Light Gradient Boosting Machine (LightGBM) model. In an example embodiment, the buyer retention forecasting system 101 trains the 360-degree customer view models to provide a comprehensive understanding of a customer's data including contact information, purchasing history, and interactions across touchpoints. The buyer retention forecasting system 101 integrates survival analysis with predictive modeling.

In an example embodiment, the buyer retention forecasting system 101 trains the Cox Proportional Hazards model using purchase frequency data, recency of last purchase, total purchase value, average order value, engagement metrics, customer lifetime value, behavioral segmentation, data product category preferences, channel preferences, geographic location, inactive period length, and customer satisfaction data. In an example embodiment, the input to the Cox Proportional Hazards model are as follows:
1. Purchase Frequency: Number of purchases per customer.
2. Recency of Last Purchase: Time elapsed since the last purchase.
3. Total Purchase Value: Sum of total spending per customer.
4. Average Order Value: Total spending divided by the number of orders.
5. Engagement: Email opens, clicks, and website visits.
6. Churn Rate: Ratio of lost customers to the total.
7. Lifetime Value: Predicted future value based on historical data, using models such as Customer Lifetime Value (CLV).
8. Product Category Preferences: Categories of products purchased.
9. Channel Preferences: Purchase channels (i.e., online, in-store, etc.).
10. Geographic Location/Demographics: Customer addresses or IP geolocation.
11. Behavioral Segmentation: Grouping based on behavior patterns.
12. Inactive Period Length: Time since last activity. (i.e., purchase, login, etc.).
13. Customer Satisfaction: Surveys, reviews, sentiment analysis.
14. Promotion Responsiveness: Reaction to discounts.
15. Social Media Engagement: Social media interactions.
16. Customer Service Interactions: Inquiries, complaints, resolutions.
17. Loyalty Program Participation: Active members.
18. Abandoned Cart Rate: Instances of incomplete purchases.

The output of the Cox Proportional Hazards model is the survival property, i.e., likelihood of a customer remaining active over time. In an example embodiment, the survival property is a continuous value between 0 and 1, indicating the probability of a customer remaining active.

In an example embodiment, the buyer retention forecasting system 101 calculates the Customer Lifetime Value (CLV) using average annual revenue per customer, churn rate, and average customer lifespan. The average annual revenue per customer is the total revenue generated by a customer in a year. In an example embodiment, the customer lifetime value is a crucial metric, representing the predicted total value a customer will generate for a company over the customer's relationship with the company. The CLV estimates the net profit a company can expect from a customer throughout the customer's engagement with the company. The CLV considers factors such as repeat purchases, average transaction value, and retention rates. The CLV quantifies the long-term value of acquiring and retaining customers. The CLV helps companies allocate resources effectively, and guides decisions related to customer acquisition, retention, and marketing spend. A high CLV indicates strong customer loyalty and profitability. Enhancing CLV improves the customer experience so as to retain customers, upsells and cross-sells to increase revenue, and targets high-value customer segments.

The CLV is calculates as CLV=(Average Annual Revenue per Customer/Churn Rate) x Average Customer Lifespan. The Average Annual Revenue per Customer is the total revenue generated by a customer in a year. The Churn Rate is the rate at which customer cease doing business with the company. The Average Customer Lifespan is the average duration a customer remains active.

The Average Annual Revenue per Customer represents the total revenue generated by a customer in a year, including both product purchases and any associated services. The Average Annual Revenue per Customer is calculated using the Total Purchase Value (TPV) and the Purchase Frequency. The TPV is the sum of all purchases made by the customer, including deployment and support services. The Purchase Frequency indicates how often the customer makes a purchase. In an example embodiment, the buyer retention forecasting system 101 calculates the Average Annual Revenue per Customer by summing total purchase values including deployment and support services and dividing by purchase frequency. In other words, Average Annual Revenue per Customer=TPV/Purchase Frequency.

In an example embodiment, the buyer retention forecasting system 101 calculates the Average Customer Lifespan by measuring average time between purchases and calculating the reciprocal of average time between purchases. The Average Customer Lifespan represents the average duration a customer remains active. It is the reciprocal of the average time between consecutive purchases or interactions by the customer. In other words, the “Average Time Between Purchases” refers the typical time interval (in days, months, etc.) between successive interactions with the company, for example making a purchase, etc. Thus, the Average Customer Lifespan=1/Average Time Between Purchases.

The Churn Rate measures the rate at which customer stop doing business with the company, and is typically expressed as a percentage. In an example embodiment, the buyer retention forecasting system 101 determines the Average Customer Lifespan and uses the Average Customer Lifespan to determine the Churn Rate as a percentage. The Average Customer Lifespan is the average duration a customer remains active. The Churn Rate=(1/Average Customer Lifespan)×100%.

At 206, the buyer retention forecasting system 101 trains a Light Gradient Boosting Machine (LightGBM) model using the Cox Proportional Hazards model to predict buyer state transitions. As noted above, the buyer retention forecasting system 101 trains two models during the model training stage. The buyer retention forecasting system 101 trains the Cox Proportional Hazards model, and then trains the the LightGBM model using survival probabilities from the Cox Proportional Hazards model, and feature bucket data. The output is the buyer status change that predicts whether a customer will transition from an active state to a latent active state or a lapsed state. The value of the buyer status change may be categorical values such as “active”, “latent active”, or “lapsed”. The combination of the two models provides a 360-degree customer view, providing a comprehensive understanding of a customer's data, such as contact information, purchasing history, and interactions across touchpoints. The buyer retention forecasting system 101 combines methods to gain a comprehensive view of buyer trends and predicts active buyer lapses.

The buyer retention forecasting system 101 integrates survival analysis with predictive modeling. Survival analysis provides insights into how long buyers remain active before lapsing, and utilizes techniques like the Cox Proportional Hazards model. The survival analysis assists in understanding the survival probabilities over time. If the probability is less than the threshold value set by the customer engagement team, the buyers fall under the status of “latent active buyer”.

The predictive modeling provided by the LightGBM model predicts future behavior based on historical data, and considers features such as purchase history, engagement, and demographics, etc. The buyer retention forecasting system 101 uses Gradient Boosting for this purpose. The buyer retention forecasting system 101 creates a holistic understanding of buyer behavior by combining the two approaches of survival analysis and predictive modeling to make informed predictions about when active buyers might transition into “Latent Active Buyers”.

At 208, in the monitoring stage, the buyer retention forecasting system 101 periodically monitors buyer state transitions to determine if a buyer has transitioned from an active state to at least one other buyer state. In an example embodiment, the buyer retention forecasting system 101 periodically monitors the buyer state predictions provided by the 360-degree customer view models (i.e., using the survival analysis and prediction provided by the two trained models). In other words, the buyer retention forecasting system 101 periodically checks if the buyer is transitioning from an active buyer state to a latent active stage or a lapsed state. Initially, when a customer makes a purchase, the customer (also referred to as a “buyer”) is in an active state. A buyer in a latent active state is initially in an active state but may not exhibit frequent interactions. As the buyer's interactions decrease significantly, the buyer eventually transitions into a lapsed state.

In an example embodiment, the buyer retention forecasting system 101 utilizes the survival analysis determined from the model training stage. The survival analysis estimates the time until an event occurs. The event, in this example scenario is a buyer transitioning to a lapsed state. In an example embodiment, the buyer retention forecasting system 101 analyzes survival probabilities by estimating survival probabilities over time and identifying factors influencing the transition (for example, the time since the last interaction, demographics, etc.). The buyer retention forecasting system 101 then predicts future transitions from active to latent active states and identifies the risk of transition to lapsed state.

In an example embodiment, the buyer retention forecasting system 101 applies the LightGBM model (from the model training stage) to predict buyer scores, where higher scores indicate active buyers.

In an example embodiment, in the corrective actions stage, the buyer retention forecasting system 101 determines corrective actions based on the predictions from the 360-degree customer view model. In an example embodiment, the corrective actions are taken from the fix model which is training using regression trees with a detailed feature set. In an example embodiment, the detailed feature set comprises the issue (i.e., the specific problems identified in buyer interactions), the feature (i.e., attributes related to buyer behavior and engagement), and feature bucket (i.e., grouped features for simplified analysis). In an example embodiment, the buyer retention forecasting system 101 determines corrective actions based on the detected buyer state transition and implements the corrective actions to transition the buyer state back to the active state.

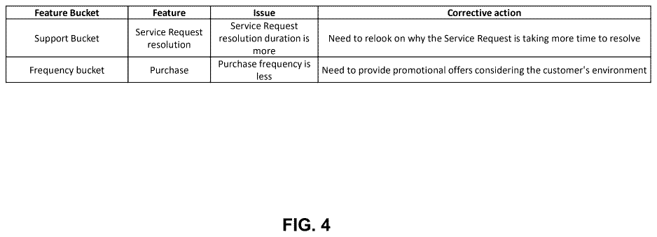

In an example embodiment, the buyer retention forecasting system 101 generates generating a fix model using regression trees trained on past corrective actions, outcomes data, and feature impact analysis. In an example embodiment, the buyer retention forecasting system 101 trains the fix model by collecting labeled data on past corrective actions and their outcomes and uses this data to train the regression trees to predict the most effective corrective actions. Corrective actions are generated by analyzing the impact of different features on buyer status. For example, if the support bucket and frequency bucket are impacted, corrective actions such as improving support resolution times or offering promotional discounts are implemented. In essence, the corrective actions are applied in a targeted manner to address specific issues identified by the fix model. FIG. 4 illustrates the feature bucket, the feature, the issue, and the corrective action.

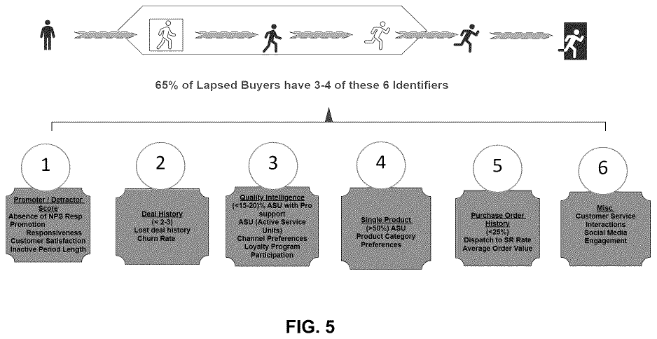

In an example embodiment, the buyer retention forecasting system 101 maps key identifiers for lapsed buyer behavior comprising promoter/detractor scores, deal history, quality intelligence, product preferences, purchase order history, and customer service interactions. In an example embodiment, 65% of lapsed buyers have 3 to 4 of these 6 identifies. FIG. 5 illustrates 6 example key identifiers mapped to feature set.

In an example embodiment, in the engagement stage, the buyer retention forecasting system 101 notifies different teams and provides a necessary action. For example, the buyer retention forecasting system 101 may notify the sales team, marketing team, customer support team, product team, data analytics team, and/or leadership team. A collaborative effort across different teams ensures an effective seamless strategy to re-engage buyers.

For example, for the sales team, the purpose of the notification is to inform the sales team about the list of at-risk buyers. An example notification might read, “Hi Team, please find attached the list of at-risk buyers identified by our 360-degree customer view model. These buyers have shown a decline in engagement, possibly due to issues with support resolution times”. The recommended action may advise, “Encourage personalized outreach, such as phone calls or personalized emails, to re-establish connections and offer tailored solutions or promotions. For example, could a sales representative reach out to this particular customer offering a 10% discount on their next purchase? Also, highlight our improved support resolution times and new product line that may interest them”.

For the marketing team, the purpose of the notification may be to share insights and data on at-risk buyers with the marketing team. An example notification might read, “Marketing Team, attached are the insights and data on our at-risk buyers from the fix model. This includes their purchase history, engagement metrics, and feedback indicating a preference for promotional discounts”. The recommended action may advise, “Develop targeted marketing campaigns, such as retargeting ads, personalized email campaigns, and special offers to re-engage these buyers. For example, Let's create a retargeting ad campaign focusing on these buyers, offering them a special promotion to encourage re-engagement. Additionally, we can send personalized emails highlighting the discounts and new product features”.

For the customer support team, the purpose of the notification may be to update the customer support team about potential issues or feedback from at-risk buyers. An example notification might read, “Customer Support Team, please review the attached feedback from our at-risk buyers. Some have reported issues with product quality and delivery times, which have been identified by our model”. The recommended action may advise, “Provide proactive support, resolve any outstanding issues, and ensure a smooth and positive experience for the buyers. For example, can we proactively reach out to these buyers to address their concerns and offer solutions? For instance, expedite any pending deliveries and offer a small gesture of goodwill for the inconvenience”.

For the product team, the purpose of the notification is to inform the product team about any feedback or trends observed from at-risk buyers. An example notification might read, “Product Team, here is the feedback from our at-risk buyers. Many have mentioned that they would like to see more eco-friendly packaging options, as identified by our model”. The recommended action may advise, “Use this feedback to make necessary improvements or adjustments to the products or services offered. For example, can we explore more sustainable packaging options and perhaps run a pilot program to gauge customer response”.

For the data analytics team, the purpose of the notification is to ensure the data analytics team is aware of the need for continuous monitoring of buyer engagement metrics. An example notification might read, “Data Analytics Team, please continue to monitor the engagement metrics of our buyers, especially those identified as at-risk by the fix model”. The recommended action may advise, “Analyze data to identify patterns and provide insights that can help in refining re-engagement strategies. For example, could you analyze the recent drop in engagement and identify any common patterns or triggers? This will help us refine our re-engagement strategies”.

For the leadership team, the purpose of the notification is to keep the leadership team informed about the status and progress of re-engagement efforts. An example notification may read, “Leadership Team, here is the latest update on our re-engagement efforts with at-risk buyers. We have seen a 15% increase in re-engagement over the past month, thanks to the targeted actions identified by our model”. The proposed action may advise, “Ensure alignment with overall business goals and secure any necessary resources or support for the initiatives. For example, to further boost our efforts, we may need additional resources for the marketing team to expand our targeted campaigns. Your support in this would be greatly appreciated”.

The above-described illustrative embodiments provide significant advantages relative to conventional approaches. For example, some embodiments are configured to identify and predict which active buyers will transition into lapsed buyers. These and other embodiments can effectively improve revenue, customer retention, and brand perception. Embodiments disclosed herein predict and anticipate customer transitions from active to lapsed status before it occurs, allowing for timely interventions. Embodiments disclosed herein capture the latent active state of customers and predict when they might transition to a lapsed state. Embodiments disclosed herein integrate corrective actions directly into the framework for timely responses to potential customer lapses so as to influence customer behavior. Embodiments disclosed herein model time-to-event data (i.e., customer churn). Embodiment disclosed herein provide predictive modeling using LightGBM, a gradient boosting framework that offers advantages in terms of speed and interpretability.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

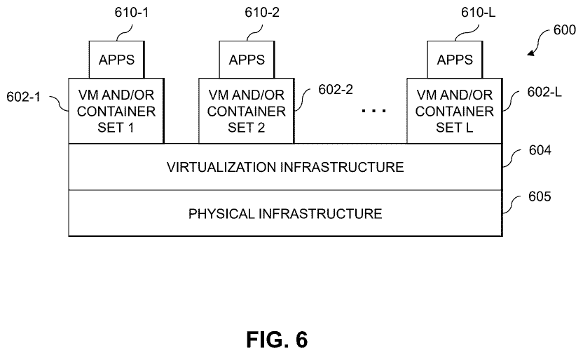

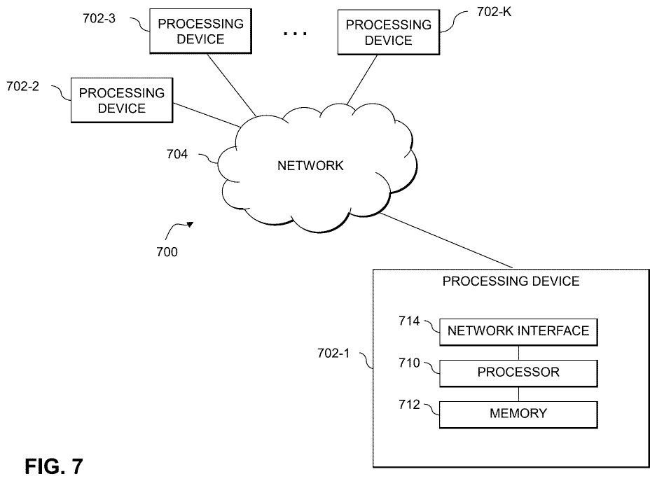

Illustrative embodiments of processing platforms will now be described in greater detail with reference to FIGS. 6 and 7. Although described in the context of the information processing system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, where the hypervisor platform has an associated virtual infrastructure management system. The underlying physical machines comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of the information processing system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a microcontroller, an application-specific integrated circuit (ASIC), a field-programmable gate array (FPGA) or other type of processing circuitry, as well as portions or combinations of such circuitry elements.

The memory 712 comprises random access memory (RAM), read-only memory (ROM) or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
collecting historical buyer data comprising order experience, deployment experience, and support experience from enterprise hardware devices;
preparing feature buckets using the historical buyer data;
training a Cox Proportional Hazards Model using the historical buyer data;
training a Light Gradient Boosting Machine (LightGBM) model using the Cox Proportional Hazards Model to predict buyer state transitions; and
periodically monitoring buyer state transitions to determine if a buyer has transitioned from an active state to at least one other buyer state, wherein the method is implemented by at least one processing device comprising a processor coupled to a memory.

2. The method of claim 1 wherein collecting the historical buyer data comprises:
gathering the order experience data comprising customer name, physical address, hardware details, and order information.

3. The method of claim 1 wherein collecting the deployment experience data comprises:
collecting system deployment details, data migration records, BIOS configuration data, asset tagging information, and installation records.

4. The method of claim 1 wherein collecting the support experience data comprises:
collecting PC optimization records, proactive self-healing scripts, support ticket history, and chatbot interactions.

5. The method of claim 1 wherein preparing feature buckets using the historical buyer data comprises:
categorizing recentness of purchases into discrete bins;
grouping frequency of purchases;
dividing monetary values into ranges; and
creating engagement level classifications.

6. The method of claim 1 wherein preparing feature buckets using the historical buyer data comprises:
creating monetary value buckets for total spending ranges and engagement buckets for email and website interactions.

7. The method of claim 1 wherein training the Cox Proportional Hazards Model comprises:
training the Cox Proportional Hazards Model using purchase frequency data,
recency of last purchase, total purchase value, average order value, engagement metrics, customer lifetime value, and behavioral segmentation data.

8. The method of claim 1 wherein training the Cox Proportional Hazards Model comprises:
training the Cox Proportional Hazards Model using product category preferences,
channel preferences, geographic location, inactive period length, and customer satisfaction data.

9. The method of claim 1 wherein training a Light Gradient Boosting Machine (LightGBM) model comprises:
training the LightGBM model using survival probabilities from the Cox Proportional Hazards Model, and feature bucket data.

10. The method of claim 1 wherein periodically monitoring buyer state transitions comprises:
analyzing survival probabilities;
predicting transitions from active to latent active states; and
identifying risk of transition to lapsed state.

11. The method of claim 1 further comprising:
determining corrective actions using regression trees based on the detected buyer state transition; and
implementing the corrective actions to transition the buyer state back to the active state.

12. The method of claim 11 wherein determining corrective actions using regression trees comprises:
training the regression trees on past corrective actions and their outcomes.

13. The method of claim 11 wherein determining corrective actions comprises:
generating a fix model using regression trees trained on past corrective actions, outcomes data, and feature impact analysis.

14. The method of claim 1 further comprising calculating a Customer Lifetime Value (CLV) using average annual revenue per customer, churn rate, and average customer lifespan.

15. The method of claim 14 wherein calculating the average annual revenue per customer comprises:
summing total purchase values including deployment and support services; and
dividing by purchase frequency.

16. The method of claim 14 wherein calculating churn rate comprises:
determining average customer lifespan; and
using the average customer lifespan to determine the churn rate as a percentage.

17. The method of claim 14 wherein calculating average customer lifespan comprises:
measuring average time between purchases; and
calculating the reciprocal of average time between purchases.

18. The method of claim 1 further comprising:
mapping key identifiers for lapsed buyer behavior comprising promoter/detractor scores, deal history, quality intelligence, product preferences, purchase order history, and
customer service interactions.

19. A system comprising:
at least one processing device comprising a processor coupled to a memory;
the at least one processing device being configured:
to collect historical buyer data comprising order experience, deployment experience, and support experience from enterprise hardware devices;
to prepare feature buckets using the historical buyer data;
to train a Cox Proportional Hazards Model using the historical buyer data;
to train a Light Gradient Boosting Machine (LightGBM) model using the Cox Proportional Hazards Model to predict buyer state transitions; and
to periodically monitor buyer state transitions to determine if a buyer has transitioned from an active state to at least one other buyer state.

20. A computer program product comprising a non-transitory processor-readable storage medium having stored therein program code of one or more software programs, wherein the program code when executed by at least one processing device causes the at least one processing device:
to collect historical buyer data comprising order experience, deployment experience, and support experience from enterprise hardware devices;
to prepare feature buckets using the historical buyer data;
to train a Cox Proportional Hazards Model using the historical buyer data;
to train a Light Gradient Boosting Machine (LightGBM) model using the Cox Proportional Hazards Model to predict buyer state transitions; and
to periodically monitor buyer state transitions to determine if a buyer has transitioned from an active state to at least one other buyer state.
